(19) United States
(12) Patent Application Publication
(10) Pub. No.: US 2008/0178862 A1
(43) Pub. Date: Jul. 31, 2008

(54) Barbecue grill with height-adjustable legs and wire mesh

(76) Inventors: Jing Feng, Beiguan Town (CN); Wei Xin Feng, Beiguan Town (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/699,376

(22) Filed: Jan. 30, 2007

(51) Int. Cl. A47J 37/07

(52) U.S. Cl. 126/25 B

(57) ABSTRACT

A barbecue grill includes a charcoal tray having a plurality of upward extended supporting brackets, which are formed at different heights with at least two locating notches each; a wire mesh supported on the locating notches at different heights depending on actual needs; and a supporting leg assembly located below the trip tray. The supporting leg assembly includes a primary leg and at least two secondary legs, all of which are length-adjustable sectional legs consisting of a plurality of detachably connected sections each, and a binding element screwed to the primary leg at a predetermined point for loosely binding the primary leg and the secondary legs together. The primary and secondary legs are screwed at upper locking ends to holding-down devices provided at an underside of the charcoal tray, such that the legs bound by the binding element are inclined to outward stretch lower ends in different directions.

### FIELD OF THE INVENTION

The present invention relates to a barbecue grill, and more particularly to a barbecue grill with length-adjustable sectional legs to enable adjustment of a distance between a charcoal tray of the barbecue grill and the ground, and with supporting brackets for supporting a wire mesh of the barbecue grill at different heights relative to the charcoal tray according to actual need.

### BACKGROUND OF THE INVENTION

Barbecue has become one of many very popular outdoor leisure activities among most people in the modern society. There are various types and sizes of barbecue grills available in the market. To attract consumers, barbecue grill manufacturers constantly develop and introduce new and improved barbecue grills into the market. Most of the conventional barbecue grills are provided at a lateral side of a charcoal tray with a vent to enable good airflow and accordingly complete burning of charcoal in the charcoal tray; above the charcoal tray with a scaled wire mesh adjusting rack; and below the charcoal tray with a set of supporting legs, so that the charcoal tray and the wire mesh of the barbecue grill are located at a height convenient for roasting or grilling food.

The wire mesh adjusting racks in the conventional barbecue grills are usually located above only one side of the charcoal tray. As a result, foods to be grilled or roasted could not be positioned directly over the charcoal tray to be heated evenly, and a lot of space and heat above the charcoal tray are wasted.

Moreover, since the vent is provided at only one lateral side of the charcoal tray in the conventional barbecue grill, it is not sufficient for the charcoal piled at a central area of the charcoal tray to burn completely. Therefore, a user has to frequently turn and stir the charcoal to expose a lower portion thereof to fresh air for burning completely. However, foods on the wire mesh above the charcoal tray would be undesirably contaminated by flying dust from the turned and stirred charcoal to cause sanitary problem.

### SUMMARY OF THE INVENTION

A primary object of the present invention is to provide a barbecue grill provided around a charcoal tray thereof with a plurality of spaced supporting brackets, on each of which a plurality of locating notches are formed at different heights for supporting a wire mesh over the charcoal tray at different distances depending on actual need.

Another object of the present invention is to provide a barbecue grill having a charcoal tray enabling good air convection. The charcoal tray is stamped at a bottom to form a plurality of upward protruded portions, which enable good air convection and therefore provide a good burning environment in the charcoal-filled charcoal tray 1.

A further object of the present invention is to provide a barbecue grill having a supporting leg assembly located below a charcoal tray of the barbecue grill. The supporting leg assembly includes a plurality of length-adjustable sectional legs consisting of a plurality of detachably connected sections each. The sectional legs are loosely bound together near upper locking ends using a binding element, and screwed at the upper locking ends to an underside of the charcoal tray, such that lower ends of the legs are stretched outward in directions to stably support the barbecue grill on the ground.

With the locating notches formed on the supporting brackets at different heights, the wire mesh may be supported over the charcoal tray at different heights depending on actual need to avoid scorched food. The upward protruded portions on the bottom of the charcoal tray enable good air convection and accordingly, good burning environment at the charcoal-filled charcoal tray. The sectional legs enable adjustment of the charcoal tray of the barbecue grill to a horizontal position at any desired height relative to the ground, making the barbecue grill more practical and convenient for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a barbecue grill with height-adjustable legs and wire mesh according to a preferred embodiment of the present invention;

FIG. 2 is a partially assembled view of FIG. 1;

FIG. 3 is an enlarged view of the circled area A of FIG. 1;

FIG. 4 is an enlarged view of the circled area B of FIG. 1;

FIG. 5 is an enlarged view of the circled area C of FIG. 2; and

FIG. 6 is a bottom perspective view of the barbecue grill of the present invention showing the assembling of a supporting leg assembly to an underside of a charcoal tray.

### DETAILED DESCRIPTION OF THE PREFERRED EMBODIMENTS

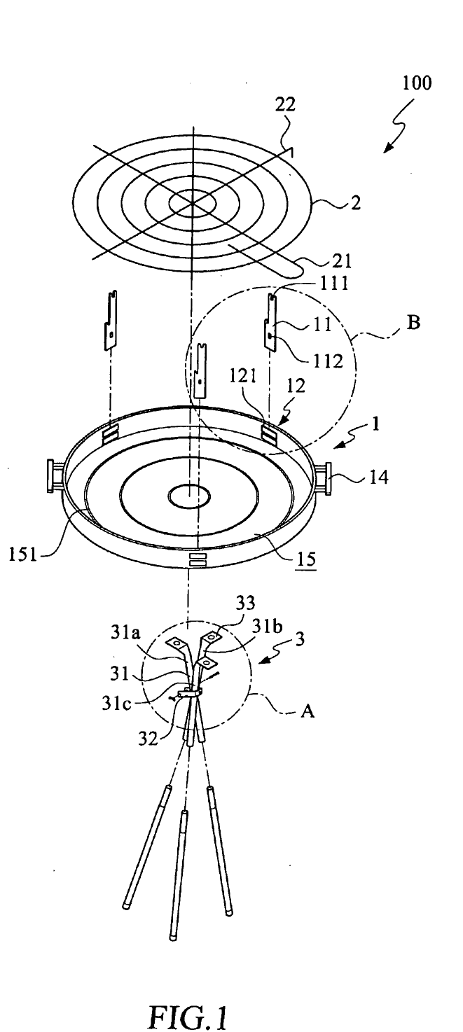

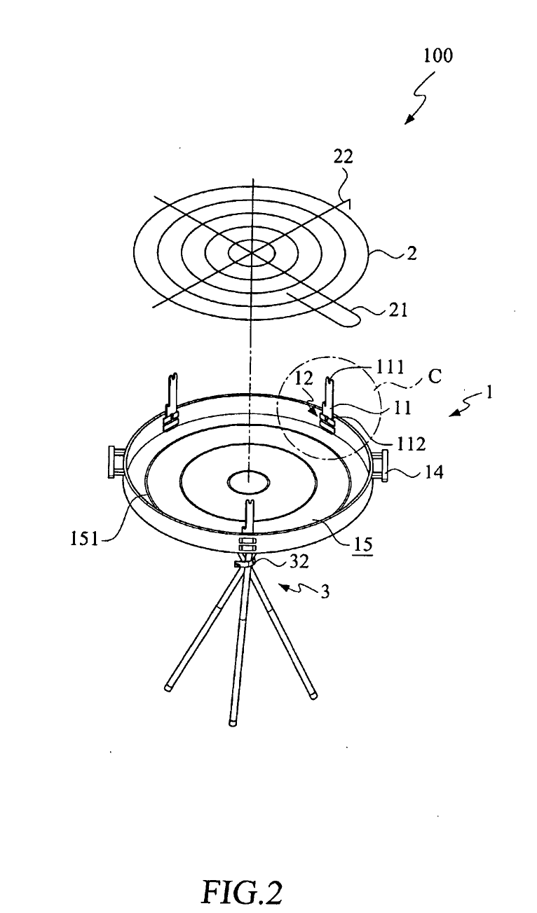

Please refer to FIGS. 1 and 2 that are exploded and partially assembled perspective views, respectively, of a barbecue grill 100 according to a preferred embodiment of the present invention. As shown, the barbecue grill 100 includes a charcoal tray 1, a wire mesh 2 supported over the charcoal tray 1, and a supporting leg assembly 3 located below the charcoal tray 1.

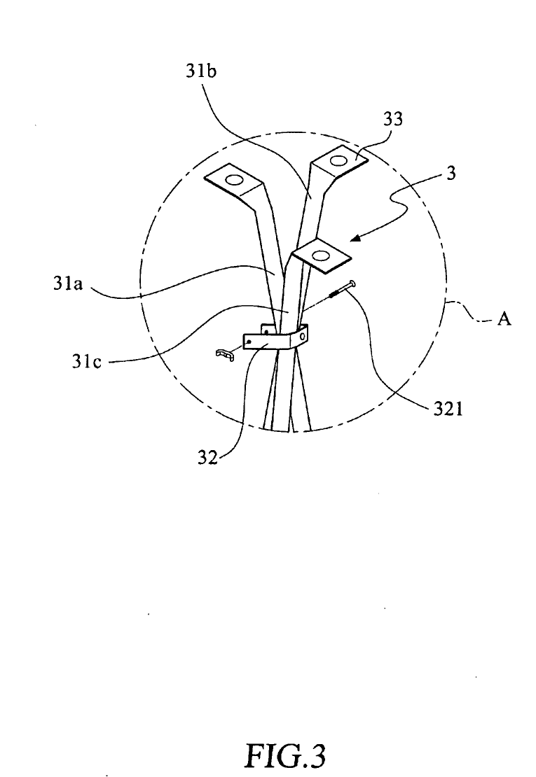

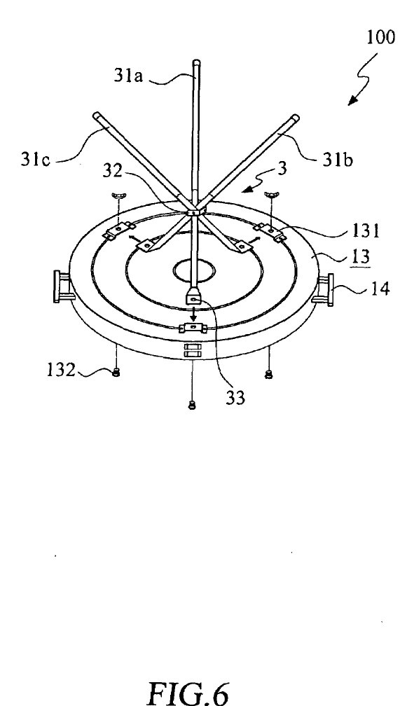

Please refer to FIGS. 1 and 2 along with FIG. 3, which is an enlarged view of the circled area A of FIG. 1. The supporting leg assembly 3 includes a primary leg 31a, at least two secondary legs 31b, 31c, and a binding element 32 fixedly screwed to the primary leg 31a. All the primary and secondary legs 31a, 31b, 31c have an upper locking end 33 for screwing to an underside 13 of the charcoal tray 1 (see FIG. 6). The binding element 32 is screwed to the primary leg 31a at a predetermined point in the vicinity of the upper locking end 33 thereof, such that a predetermined distance exists between the binding element 32 and the upper locking end 33. The two secondary legs 31b, 31c are loosely enclosed in the binding element 32, such that the primary and the secondary legs 31a, 31b, 31c may be inclined by an angle with the binding element 32 serving as a support point, so as to outward stretch respective lower ends in different directions.

As can be clearly seen from FIG. 3, the binding element 32 is a U-shaped member being screwed at a transverse section to the predetermined point on the primary leg 31a. When the two secondary legs 31b, 31c have been loosely enclosed in the binding element 32, free ends of two longitudinal sections of the U-shaped binding element 32 are locked together using a screw 321. It is understood the binding element 32 may be otherwise welded to the predetermined point on the primary leg 31a close to the upper locking end 33.

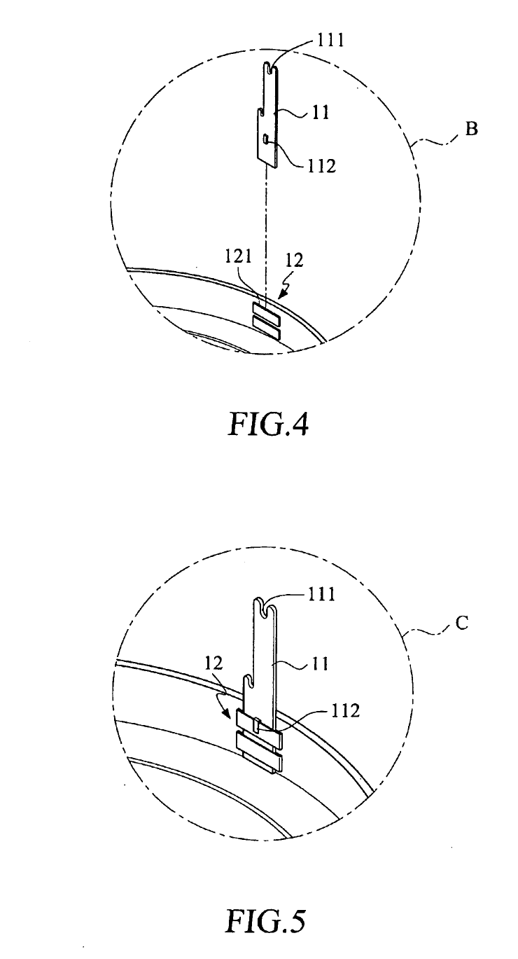

FIGS. 4 and 5 are enlarged views of the circled areas B and C in FIGS. 1 and 2, respectively. Please refer to FIGS. 1 and 2 along with FIGS. 4 and 5. The charcoal tray 1 is used to hold charcoal therein, and is formed along a peripheral wall with a plurality of spaced clamping sections 12, to which a plurality of supporting brackets 11 are separately assembled.

Each of the clamping sections 12 is preferably formed by inward stamping a predetermined position on the peripheral wall of the charcoal tray 1, so that a gap 121 is produced between the inward stamped clamping section 12 and the peripheral wall of the charcoal tray 1. Each of the supporting brackets 11 is formed at different heights with at least two locating notches 111, and preferably stamped within a lower part below the locating notches 111 to form an inward and downward bent tab 112. To assemble the supporting bracket 11 to the clamping section 12, simply downward insert the supporting bracket 11 into the gap 121 with the bent tab 112 hooked to a top of the inward stamped clamping section 12, such that the locating notches 111 are located above the peripheral wall of the charcoal tray 1.

The wire mesh 2 includes a handle 21 and a plurality of locating wires 22. The handle 21 is formed from one of the locating wires 22 by bending an extended end of that locating wire 22 into a desired shape. The locating wires 22 are so spaced on the wire mesh 2 that they may be fitly set in a group of the locating notches 111 provided at the same height on the supporting brackets 11. By setting the locating wires 22 in the locating notches 111 at a higher position on the supporting brackets 11, the wire mesh 2 may be supported over the charcoal tray 1 with a larger distance existed between them. On the other hand, when the locating wires 22 are set in the locating notches 111 at a lower position on the supporting brackets 11, the wire mesh 2 may be located over but closer to the charcoal tray 1.

The charcoal tray 1 is also provided at an outer side of the peripheral wall with at least one handle 14, so that a user may conveniently and safely move the charcoal tray 1 by gripping at the handle 14. A bottom 15 of the charcoal tray 1 is stamped at different positions to form a plurality of upward protruded portions 151. The upward protruded portions 151 enable good air convection and accordingly, a good burning environment in the charcoal-filled charcoal tray 1.

Please refer to FIG. 6 that is a bottom perspective view of the barbecue grill 100. As shown, the charcoal tray 1 is provided at the underside 13 with a plurality of holding-down devices 131. The upper locking ends 33 of the primary and secondary legs 31a, 31b, and 31c may be separately slid into the holding-down devices 131 and detachably connected thereto by screws 132.

It is noted the primary leg 31a and the secondary legs 31b, 31c of the supporting leg assembly 3 are sectional legs consisting of two or more detachably connected sections each, so that the supporting leg assembly 3 may be conveniently stored and carried. Preferably, the charcoal tray 1 may be adjusted to different heights or a completely horizontal position above the ground by adjusting the length of the primary and secondary legs 31a, 31b, 31c of the supporting leg assembly 3.

To erect the barbecue grill 100, first loosely bind the legs 31a, 31b, and 31c together using the binding element 32, and then use screws 132 to connect the upper locking ends 33 of the legs 31a, 31b, 31c to the holding-down devices 131 at the underside 13 of the charcoal tray 1. At this point, lower ends of the legs 31a, 31b, and 31c are automatically inclined to stretch outward in directions while the binding element 32 serves as a support point. Thereafter, insert the supporting brackets 11 into the gaps 121 with the bent tabs 112 hooked to the clamp sections 12 to hold the supporting brackets 11 in place. Then, the wire mesh 2 may be positioned over the charcoal tray 1 by setting the locating wires 22 in the locating notches 111 at a desired height on the supporting brackets 11 to keep a desired distance between the wire mesh 2 and the charcoal tray 1.

With the above arrangements, the barbecue grill 100 may have a changeable overall height relative to the ground by adjusting the length of legs 31a, 31b, 31c of the supporting leg assembly 3; and the wire mesh 2 may be positioned over the charcoal tray 1 at different heights via the locating notches 111 of the supporting brackets 11. Moreover, the present invention may be applied to various types of barbecue grills.

What is claimed is:

1. A barbecue grill with height-adjustable legs and wire mesh, comprising a charcoal tray, a wire mesh supported over the charcoal tray, and a supporting leg assembly located below the charcoal tray; the supporting leg assembly including a primary leg, at least two secondary legs, and a binding element screwed to the primary leg; all the primary and secondary legs having an upper locking end screwed to an underside of the charcoal tray; the binding element being screwed to the primary leg at a predetermined point in the vicinity of the upper locking end thereof, such that a predetermined distance exists between the binding element and the upper locking end; the two secondary legs being loosely enclosed in the binding element, such that the primary and the secondary legs may be inclined by an angle with the binding element serving as a support point thereof to thereby outward stretch respective lower ends in different directions.

2. The barbecue grill with height-adjustable legs and wire mesh as claimed in claim 1, wherein the charcoal tray includes a plurality of upward extended supporting brackets, each of which is formed with at least two locating notches located at different heights.

3. The barbecue grill with height-adjustable legs and wire mesh as claimed in claim 2, wherein the wire mesh includes a plurality of spaced locating wires for separately fitly set in a group of the locating notches located at the same height on the supporting brackets.

4. The barbecue grill with height-adjustable legs and wire mesh as claimed in claim 2, wherein the charcoal tray is formed on a peripheral wall with a plurality of spaced clamping sections, and all the supporting brackets include a bent tab corresponding to the clamping sections; and the supporting brackets being mounted on the charcoal tray by hooking the bent tabs to the clamping sections.

5. The barbecue grill with height-adjustable legs and wire mesh as claimed in claim 1, wherein the charcoal tray is provided at a predetermined position with at least one handle.

6. The barbecue grill with height-adjustable legs and wire mesh as claimed in claim 1, wherein the charcoal tray is stamped at a bottom thereof to form a plurality of upward protruded portions.

7. The barbecue grill with height-adjustable legs and wire mesh as claimed in claim 1, wherein the charcoal tray is provided at the underside with a plurality of spaced holding-down devices, such that the upper locking ends of the primary and secondary legs may be slid into the holding-down devices and screwed thereto.

8. The barbecue grill with height-adjustable legs and wire mesh as claimed in claim 1, wherein the primary and secondary legs are sectional legs consisting of a plurality of detachably connected sections each.
